(19) United States
(12) Patent Application Publication
(10) Pub. No.: US 2002/0071180 A1
(43) Pub. Date: Jun. 13, 2002

(54) Polarization insensitive optical device

(76) Inventors: Thomas Ducellier, Ottawa (CA); Neil Teitelbaum, Ottawa (CA)

Correspondence Address: JDS UNIPHASE CORPORATION, INTELLECTUAL PROPERTY DEPARTMENT, 3000 MERIVALE ROAD, OTTAWA, ON, K2G 6N7, CA

(21) Appl. No.: 09/732,780

(22) Filed: Dec. 11, 2000

(51) Int. Cl. G02F 1/29

(52) U.S. Cl. 359/483; 359/485; 359/301

(57) ABSTRACT

A device serving as an optical switch or attenuator is disclosed, based on the insertion of a halfwave plate in a collimated beam space between two lenses. All beams have first been aligned to a same polarization state by standard polarization diversity techniques. Moving the halfwave plate into or out of the beam incident thereon enables switching the beams direction based on polarization. Partial insertion of the waveplate attenuates the beam through rotation of polarization state for part of the beam. Preferably, polarizers are used to improve extinction ratio and wavelength flatness.

### FIELD OF THE INVENTION

This invention relates to a polarization insensitive optical device, which can function as an optical switch or as an optical attenuator for application in fiber optics telecommunications.

### BACKGROUND OF THE INVENTION

Optical switches which steer beams controllably from a launch location to one of may possible destination ports are well known. Once a connection is established by ensuring that two port are optically aliened via an optical path, most switches are bi-directional allowing an optical signal to be propagated from a port to a designation or visa versa. Some of these switches perform a switching function by moving a reflecting or deflecting element into a signal path or light beam; alternatively other switches, perform switching in a more passive manner by varying the refractive index of a material or by rotating the polarization of a light beam prior to it being launched into a beam steering member such as a birefringent crystal directs a beam in dependence upon its polarization state. The latter type of switch typically uses a Faraday rotator for rotating the polarization of light passing therethough in dependence of an applied voltage. An optical switch of this form is described in U.S. Pat. No. 5,694,233 in the name of Wu. Although the switch described by Wu performs its intended function, the switch in accordance with this invention is believed to be advantageous as it allows multiple optical elements to be simultaneously inserted into the path providing additional functionality.

It is a well known that fabricating an optical switch which is based on the insertion of a deflecting element or reflecting element is very difficult if the switch is to be polarization insensitive.

It is known to provide an optical attenuator or optical switch in which the collimated beam gets intercepted with some blocking or redirecting means; for example, a moving mirror. It is also known to provide a switch where the polarization state gets rotated with some controllable retardance element such as a liquid crystal cell or an electromagnetically controlled Faraday rotator.

However, the first class of prior art switch or attenuator based upon the interception of the beam with a mirror or a vane suffers from extremely tight positioning tolerances for the mirror. The second class of switches and attenuators based on liquid crystals or Faraday rotation of polarization suffers from the inability to provide high suppression ratio, especially over a large wavelength band.

It is an object of this invention to provide with an insertion mechanism that has very loose positioning tolerances.

A 0^{th} order half waveplate retardance depends only marginally on its angular position, and since its thickness is very small, the overall optical impact of misalignment of this plate with respect to the collimated beam is negligible.

It is a further advantage of this invention to provide a polarization rotation based optical device with a large extinction ratio over a broad wavelength range. This is achieved by the insertion of polarizers in the collimated beam path: a first one aligned with the polarization states of the sub-beams after the first lens and a second one to be inserted with the half waveplate and whose axis is perpendicular to that of the first polarized.

In summary, it has been found that by inserting an element which rotates the beam's polarization state into an optical system having a birefringent polarization dependent beam steering block (BPDBS) offers significant advantages over the insertion of a deflecting or reflecting element into a beam's path; by inserting a polarization rotating element followed by a BPDBS the switch is substantially or nearly polarization insensitive.

### SUMMARY OF THE INVENTION

In accordance with the invention, an optical switching or attenuating mechanism is provided based on the insertion of a half waveplate in a collimated beam space, where all beams have first been aligned to a same polarization state by standard polarization diversity techniques. Moving the half waveplate into our out of the beam incident thereon enables switching the beams direction based on polarization, whereas partial insertion of the plate attenuates the beam through rotation of polarization state for part of the beam. In a preferred embodiment, polarizers are used to improve extinction ratio and wavelength flatness.

### BRIEF DESCRIPTION OF THE DRAWINGS

Exemplary embodiments of the invention will now be described in conjunction with the drawings in which:

FIG. 1 is a top view of a polarization switch wherein the switching element is absent from between the back to back graded index (GRIN) lenses;

FIG. 2 is a top view of the polarization switch shown in FIG. 1 having a half waveplate fully inserted between the back to back graded index (GRIN) lenses;

FIG. 3 is a side view of the switch shown in FIG. 1 absent the switching element between the GRIN lenses;

FIG. 4 is a side view of the switch shown in FIG. 2 having a half waveplate fully inserted between the back to back graded index (GRIN) lenses;

FIG. 5 is a top view of the switch shown in FIG. 1 and including a polarizing filter between the two GRIN lenses;

FIG. 6 is a top view of the switch shown in FIG. 2 including a polarizing filter between the two GRIN lenses;

FIG. 7 is a side view of the optical switch shown in FIG. 5;

FIG. 8 is a side view of the switch shown in FIG. 6;

FIGS. 9 and 10 are side views of the optical switch wherein the switch can operate in an attenuating mode rather than a full switching mode of operation;

FIGS. 11 and 12 are side views of the optical switch shown in FIGS. 9 and 10 wherein the switch is configured as an optical attenuator having a half waveplate and crossed polarizing filter inserted partially into the beam's path; and,

FIG. 13 is an isometric view of a half waveplate inserted within rails between two, rod GRIN lenses.

### DETAILED DESCRIPTION

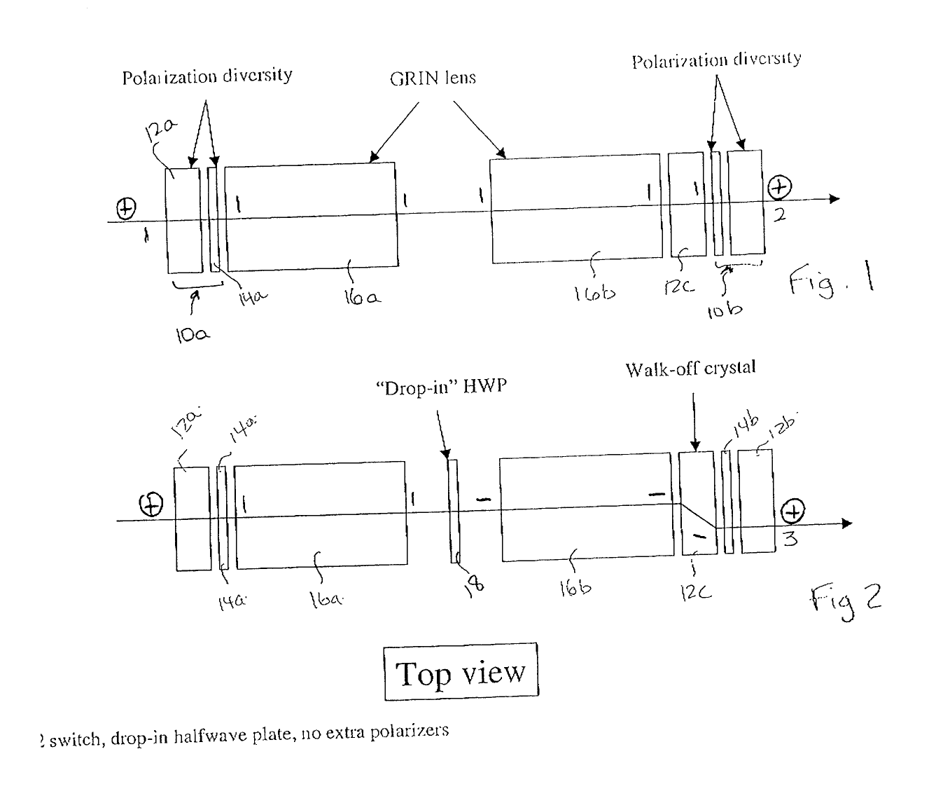

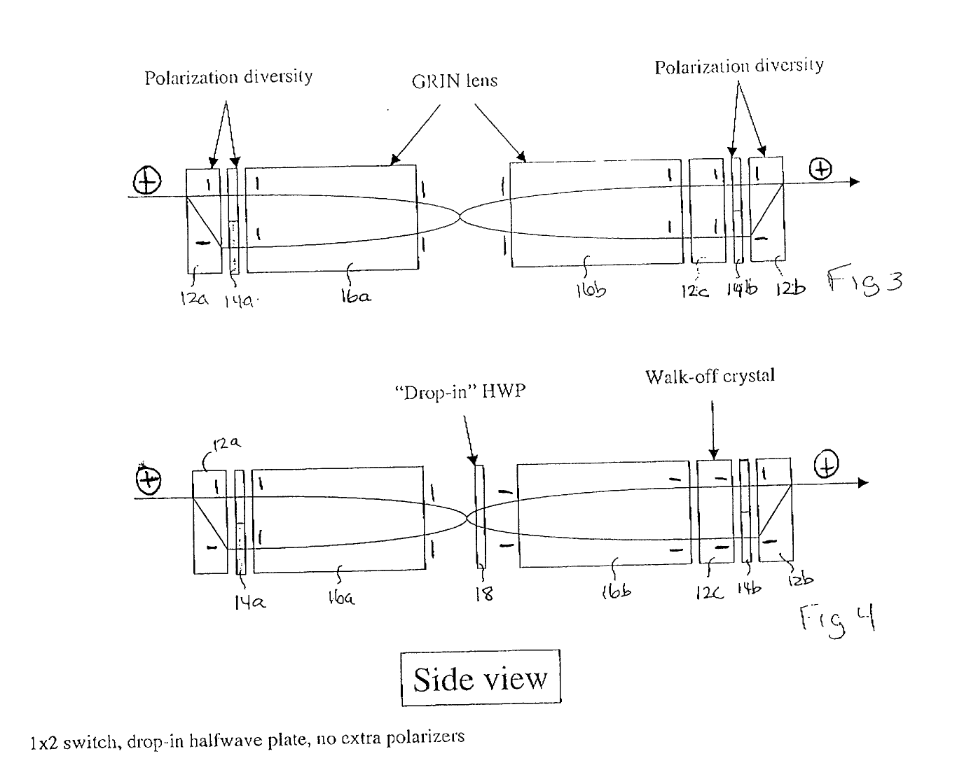

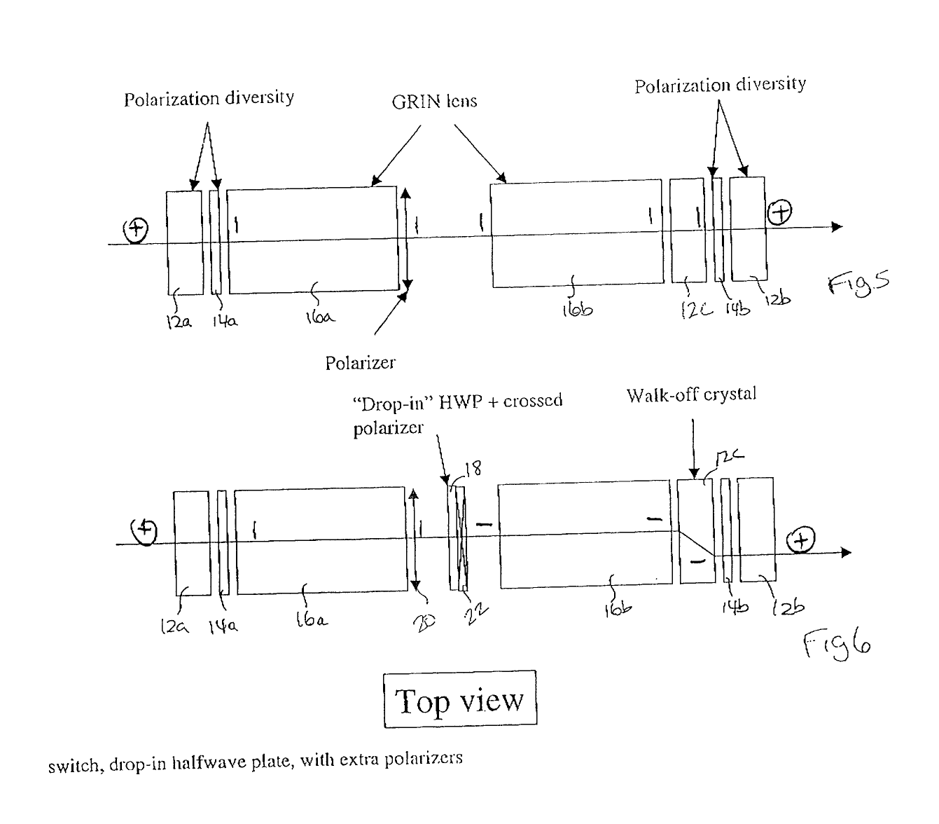

Referring now to FIGS. 1 and 2 an embodiment of an optical switch in accordance with this invention is shown, wherein a first polarization diversity block (PDB) 10a is optically coupled with a second polarization diversity block 10b via a pair of spaced back-to-back collimating GRIN lenses 16a and 16b. The first PDB 10a comprised of a birefringent crystal 12a optically coupled and adjacent to a polarization rotating element 14a such as a half waveplate. The second PDB is similarly constructed and is comprised of a birefringent crystal 12b optically coupled and adjacent to a polarization rotating element 14b such as a half waveplate. In FIG. 2 a half waveplate (HWP) 18 is shown inserted into the path: means in the form of a guide rail and actuator to for moving the HWP 18 into or out of the path of the beam are not shown in this figure. Referring now to FIGS. 1 and 3 a beam of unknown polarization is launched into the PDB 10a and is split into-two sub-beams having orthogonal polarization states as it passes through the birefringent crystal 12a; subsequently, only one of the two sub-beams is passed through a rotator 14a and is rotated by 90° so that its polarization matches that of the other sub-beam. FIG. 3 is illustrative of this and also depicts the two sub-beams being re-combined at the output end after passing through the PDB 10b; in this instance the beam essentially passes through all of the components as it would have following a straight-through path from port 1 to port 2. Referring now to FIGS. 2 and 4 the sub-beams after passing through the HWP 18 have their polarization rotated by 90° and therefore walk-off after passing through the walk-off crystal 12c which steers the beams toward port 3. Prior to being incident upon port 3 the sub-beams are combined into a single beam of mixed polarization by the PDB 10b. Thus, controllable insertion or removal of the HWP 18 determines whether the beam launched into port 1 will be incident upon port 3 or 2 respectively and a 1×2 switch is provided.

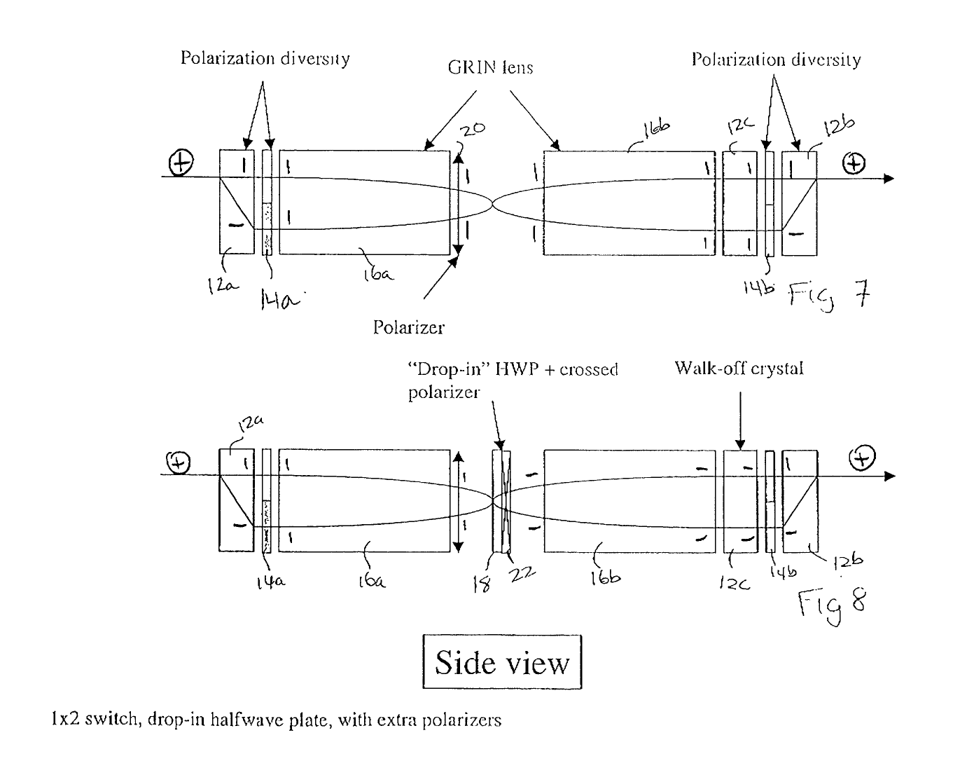

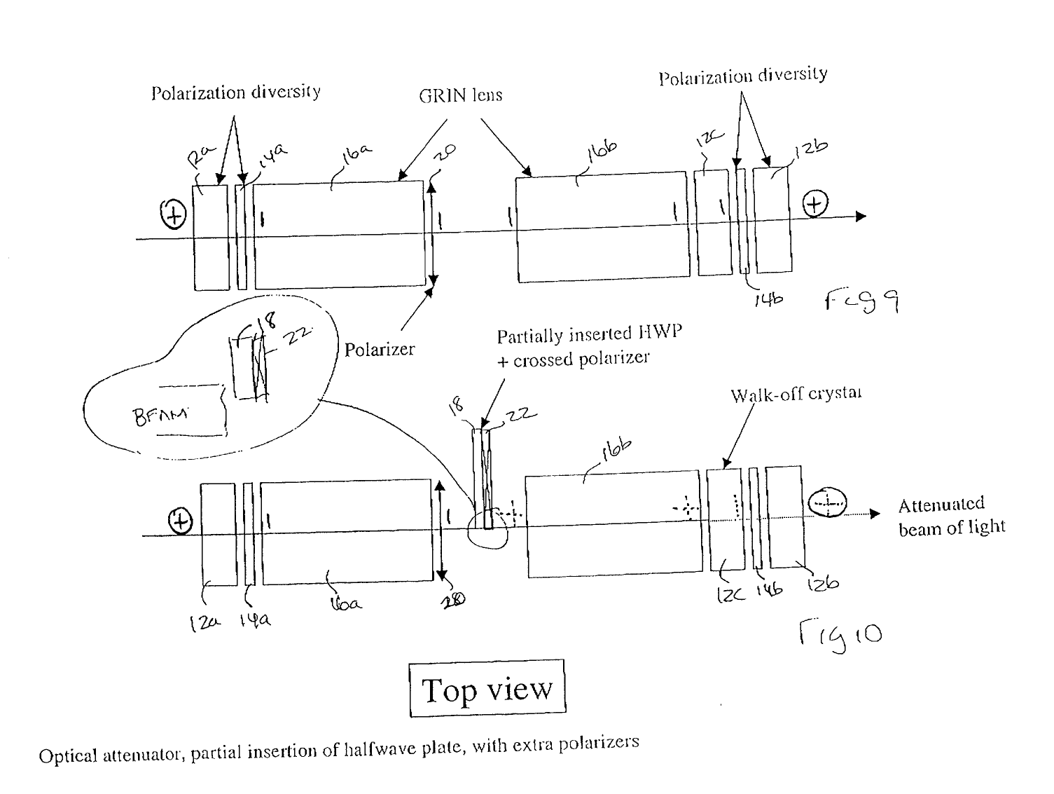

The embodiment shown in FIGS. 5 and 6 is advantageous in that it provides a polarization rotation based optical device with a large extinction ratio over a broad wavelength range. This is achieved by the provision of polarizers 20 and 22 in the collimated beam path: a permanent polarization filter 20 is aligned with the polarization states of the sub-beams propagating through the first GRIN lens 16a after the first lens; a second movable polarizing filter optically coupled with the HWP 18 is inserted with the HWP 18; the axis of the filter 22 is perpendicular to that of the first polarizing filter 20. The provision of the first filter 20 provides additional isolation or filtering of the polarized sub-beams exiting the GRIN lens 16a; The provision of the second filter 22 provides additional isolation or filtering of the polarized sub-beams entering the GRIN lens 16b; essentially 20 is disposed to correct for PDB preceding it, and 22 is disposed to corrects for the drop-in HWP 18 by providing additional filtering. FIGS. 7 and 8 are side views of the embodiment shown in FIGS. 5 and 6.

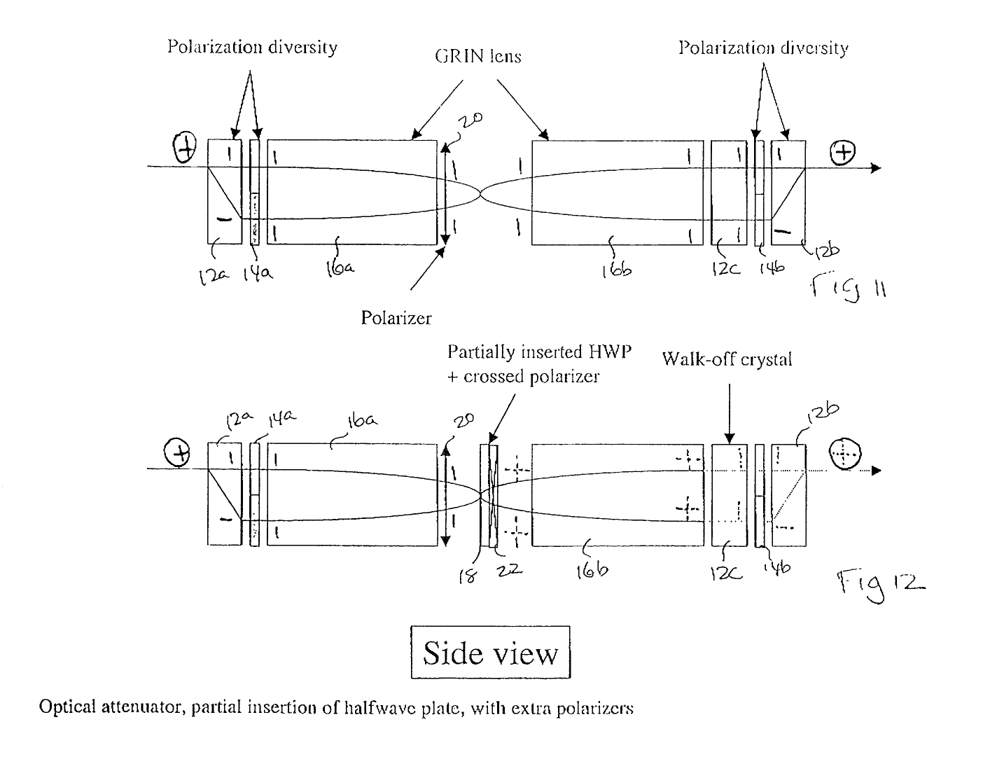

FIGS. 9 and 10 illustrate an embodiment of the invention wherein an attenuator is provided instead of a switch. Light is launched from port 1 to port 2 as shown in FIG. 9. The input beam launched into the device at port 1 is of mixed random polarization and the output beam at port 2 is of mixed polarization. Absent any unwanted coupling losses all of the light launched into port 1 propagates to port 2. Referring now to FIG. 10 HWP 18 with the filter 22 is shown partially inserted into the beam such that a portion of the beam propagates through the HWP and filter 22. This is shown in an exploded view of the beam. Since only a portion of the beam passes through the HWP 18, filter 22 combination, the remaining other portion is un-attenuated and propagates to port 2. The insertion of the filter combination has the effect of “spilling-off” light away from its destination port 2. FIGS. 11 and 12 are side views of the attenuator shown in FIGS. 9 and 10.

In operation the attenuator functions in the following manner. The input beam launched into port 1 impinges upon the first walk-off crystal 12a in order to separate the incoming beam into two sub-beams. A first polarization rotator 14a is used to align the polarization states of the two sub-beams. Those two sub-beams are then passed through lens 16a to collimate these sub-beams at a location between lens 16a and lens 16b. In the collimated path, some space is accommodated in order to be able to drop-in the half waveplate 18 and/or polarizers. The sub-beams are then refocused by the second lens 16b. After propagating through the GRIN lens 16b, they traverse the walk-off crystal 12c, whose deflection direction is different from that of the first walk-off crystal 12a. The two sub-beams go through a second polarization rotator 14b in order to have two orthogonal polarization states for each of the two sub-beams. The third walk-off crystal 12b, whose deflection direction is essentially the same as that as the first walk-off crystal, is used to recombined the two sub-beams into an output beam of light coupled to a output optical waveguide. Variable and controllable optical attenuation is obtained through partial insertion of the half waveplate in the collimated beam of light.

When a second output port is connected to the third walk-off crystal 12b at a position corresponding to that of the two sub-beams when they are deflected by the second walk-off crystal 12c, a 1×2 switch is provided. The two output ports are selectable by inserting or removing the half waveplate in the collimated path. One can have a first polarizer whose polarization is aligned with that of the two sub-beams, and or a second cross polarizer attached to the half waveplate in order to improve extinction ratio and decrease wavelength dependency of the switch.

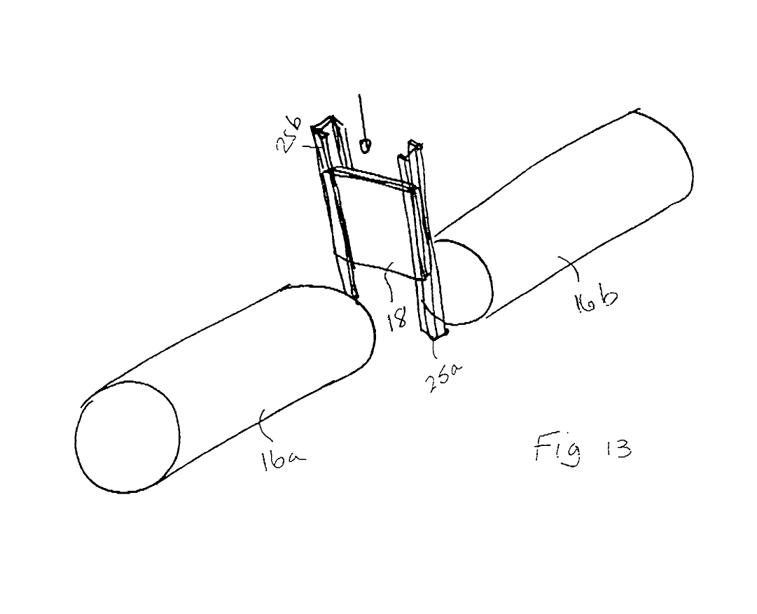

FIG. 13 illustrates one method of controlling the HWP 18 which can conveniently be placed between rails 25a and 25b. An actuator, such as a controllable piston or any other form of actuator that is typically used for moving a shutter in our out of a path in an optical device, controllably can be used. An arrow is shown representing the actuator. Of course control circuitry coupled with the actuator is provided by is not shown. The control circuitry is programmed to either operate in a switching mode by fully inserting or fully removing the HWP 18 from the path of the beam passing between the lenses 16a and 16b. Alternatively the control circuitry can be programmed to partially insert or remove the HWP 18 from the path upon receiving a control signal. Feedback circuitry including a properly disposed detector can be provided to ensure a certain level of attenuation of the beam passing therethrough.

Although the invention described in detail heretofore relates to the controlled insertion of a polarization rotation means in sub-beams of light to realize an optical attenuator or an optical switch, in which the sub-beams originates from the same input beam and whose polarization states have been aligned, other embodiments can be envisaged.

What is claimed is:

1. A method of routing an optical signal from an first port to a destination port in a controllable manner, comprising the steps of:
launching the optical signal from the first port so that the signal propagates along a first to optical path:
controllably moving a polarization rotating element into or out of the first optical path to rotate the polarization state of the optical signal;
passing the optical signal through a beam steering element for steering the optical signal in a first direction when the optical signal is in a first polarization state and for steering the optical signal in a second different direction when the optical signal is in a second different polarization state so that the optical signal can couple to the destination port when it is in one of the first and second polarization states.

2. A method of routing an optical signal as defined in claim 1, wherein the step of controllably moving the polarization rotating element is performed by only partially moving the element into or out of the path so that only a portion of the signal is rotated.

3. A method of routing an optical signal as defined in claim 2 wherein the optical signal is further passed through a polarizing element prior to being passed through the beam steering element.

3.1. A method of routing an optical signal as defined in claim 1 wherein the optical signal is further passed through a polarizing element prior to being passed through the beam steering element.

4. A method of attenuating a beam of light comprising the steps of:
launching the beam from a first optical port so that the beam propagates alone an optical path;
moving a polarization rotating element within the optical path so that a portion less than the entire beam passes through the polarziation rotating element; and
passing the beam through a polarization dependent element so that only the portion less than the entire beam or the remaining portion of the beam is directed to a destination port.

5. A method of attenuating a bream of light as defined in claim 4 wherein the polarization dependent element is a polarizer.

6. A method of attenuating a beam of light as defined in claim 5, wherein the polarization dependent element steers the beam in a first direction when it is in a first polarization state and which steers the beam in a second direction when it is in a second polarization state.

7. A method of attenuating the beam of light as defined in claim 4 further comprising the step of moving a polarizer into the path of the beam to filter the beam prior to passing the beam through the polarization dependent element.

8. A method of routing an optical signal from a first port to a destination port in a controllable manner, comprising the steps of:
launching the optical signal from the first port so that the signal propagates along a first optical path;
separating the optical signal into first and second sub-signals having a same polarization; state;
controllably moving an element that will effect polarization rotation of a light propagating therethrough into or out of the first optical path to rotate the polarization state of the first and second sub-signals;
passing the first and second sub-signals through a beam steering element for simultaneously steering the sub-signals in a first direction when the optical signal is in a first polarization state and for steering the sub-signals in a second different direction when the sub-signals are in a second different polarization state;
combining the first and second sub-signals as two orthogonally polarized beams into a single beam; and,
allowing the single beam to propagate to the destination port.

10. A method as defined in claim 9, further comprising the step of moving a polarizer element into our out of the first optical path for filtering light incident thereon.

11. A method as defined in claim 9, wherein the step of moving a polarizer element is performed simultaneously with the step of moving the element that will effect polarization rotation of light propagating therethrough.

12. An apparatus for routine an optical signal in a controllable manner by varying the polarization state of the optical signal, comprising:
a first port;
one or more destination ports for receiving the optical signal;
a beam steering element disposed between the first port and the one or more destination ports for steering the optical signal in a first direction when the optical signal is in a first polarization state and for steering the optical signal in a second different direction when the optical signal is in a second different polarization state so that the optical signal can couple to the destination port when it is in one of the first and second polarization states;
a first optical path disposed between the first port and the beam steering means;
a movable, passive, polarization-rotating element controllably movable into or out of the to first optical path for rotating the polarization state of light passing therethrough; and,
an actuator for controllably moving the passive polarization-rotating element in a into or out of the first optical path.

13. An apparatus as defined in claim 12 further comprising a controller for controlling the movement of the passive polarization-rotating clement so that it is moved partially into or out of the path and attenuates light received at one of the one or more destination ports.

14. An apparatus as defined in claim 12 further comprising a movable polarizing filter, controllably movable into or out of the first optical path for rotating the polarization state of light passing therethrough.

15. An apparatus as defined in claim 12 further comprising a stationary polarizing filter, in the first optical path for filtering light incident thereon, in a polarization dependent manner.

16. An apparatus as defined in claim 12 further comprising a polarization beam splitter for splitting the optical signal into two polarized sub-beams at an input end and a polarization beam combiner for combining the two sub-beams prior to the sub-beams being received at one of the one or more destination ports.
